(19) United States
(12) Patent Application Publication
(10) Pub. No.: US 2006/0277353 A1
(43) Pub. Date: Dec. 7, 2006

(54) Virtual tape library device, virtual tape library system, and method for writing data to a virtual tape

(76) Inventors: Yoichi Mizuno, Yokohama-shi (JP); Takashi Amano, Yokohama-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/202,144

(22) Filed: Aug. 12, 2005

(30) Foreign Application Priority Data
Jun. 2, 2005 (JP) 2005-162526

(51) Int. Cl. G06F 12/00

(52) U.S. Cl. 711/4

(57) ABSTRACT

The present invention aims to protect data by using WORM (Write Once Read Many) features. On receiving an instruction to write data to a virtual tape, from a host computer 2 via an FC interface 11, a VTL controller 10 reads out WORM information and access information each corresponding to the virtual tape for which the instruction was made, from a tape management table 231 and a WORM management table 232, respectively. If the WORM setting is not made for the WORM information that was read out, or if the access information indicates writing data is allowed, then an instruction is given to a disc device 30 to write data to a magnetic disc that corresponds to the virtual tape for which the write instruction was made.

### CLAIM OF PRIORITY

The present application claims priority from Japanese application JP 2005-162526 filed on Jun. 2, 2005, the content of which is hereby incorporated by reference into this application.

### BACKGROUND OF THE INVENTION

1. Field of the Invention

The present invention relates to a virtual tape library system.

2. Description of the Related Art

In recent years, there has been an increasing use of a virtual tape library device that a host computer recognizes as a conventional tape library but is actually recording data on a magnetic disc. Conventional virtual tape library devices include one as disclosed in US Patent Publication No. 2005-0033911 A1. In this disclosed invention, a virtual tape library device, on receiving from a host computer an instruction to mount a magnetic tape to a tape drive, selects an area on the magnetic disc in response to the instruction, and then on receiving from the computer an instruction to write data to the magnetic tape, writes the data to the area in response to the instruction,

However, the above-mentioned device had a disadvantage that the data can be overwritten by faulty operation and data manipulation.

With such a background, an objective of the present invention is to protect data by using WORM (Write Once Read Many) features that prohibit overwriting data.

### SUMMARY OF THE INVENTION

To solve the problem, the present invention provides a virtual tape library device comprising a communication interface with a host computer, a disc device comprising a plurality of magnetic discs, a memory device, and a control device for controlling the communication interface, the disc device, and the memory device, wherein the memory device comprises:

a tape management table in which to make a WORM (Write Once Read Many) setting to indicate whether a virtual tape or a target area in the virtual tape should be treated as WORM; and

a WORM management table in which to store correspondence between a tape address of the virtual tape and a disc address of each of the magnetic discs; and wherein the control device performs the Steps of:

judging from the tape management table whether the WORM setting is made for the virtual tape, on receiving from the host computer via the communication interface an instruction to write write-data to the virtual tape; and

referring to the WORM management table to specify a disc address corresponding to the tape address and instructing the disc device to write the write-data to the specified disc address, if the judgment results in that the WORM setting is not made.

### BRIEF DESCRIPTION OF THE DRAWINGS

FIG. 1 is a block diagram to illustrate a general construction including a virtual tape library device according to a first embodiment of the present invention.

FIG. 2 is a drawing to illustrate an exemplary construction of a drive management table as illustrated in FIG. 1.

FIG. 3 is a drawing to illustrate an exemplary construction of a tape position management table as illustrated in FIG. 1.

FIG. 4 is a drawing to illustrate an exemplary construction of a tape management table as illustrated in FIG. 1.

FIG. 5 is a drawing to illustrate an exemplary construction of a WORM management table as illustrated in FIG. 1.

FIG. 6 is a flowchart to illustrate an exemplary operation and processing of a virtual tape library device.

FIG. 7 is a drawing to illustrate an exemplary display of a tape production screen.

FIG. 8 is a flowchart to illustrate an exemplary operation for modifying a WORM setting.

FIG. 9 is a drawing to illustrate an exemplary display of a tape setting screen.

FIG. 10 is a block diagram to illustrate a general construction including at least one virtual tape library device according to a second embodiment of the present invention.

### DESCRIPTION OF THE PREFERRED EMBODIMENT

### First Embodiment

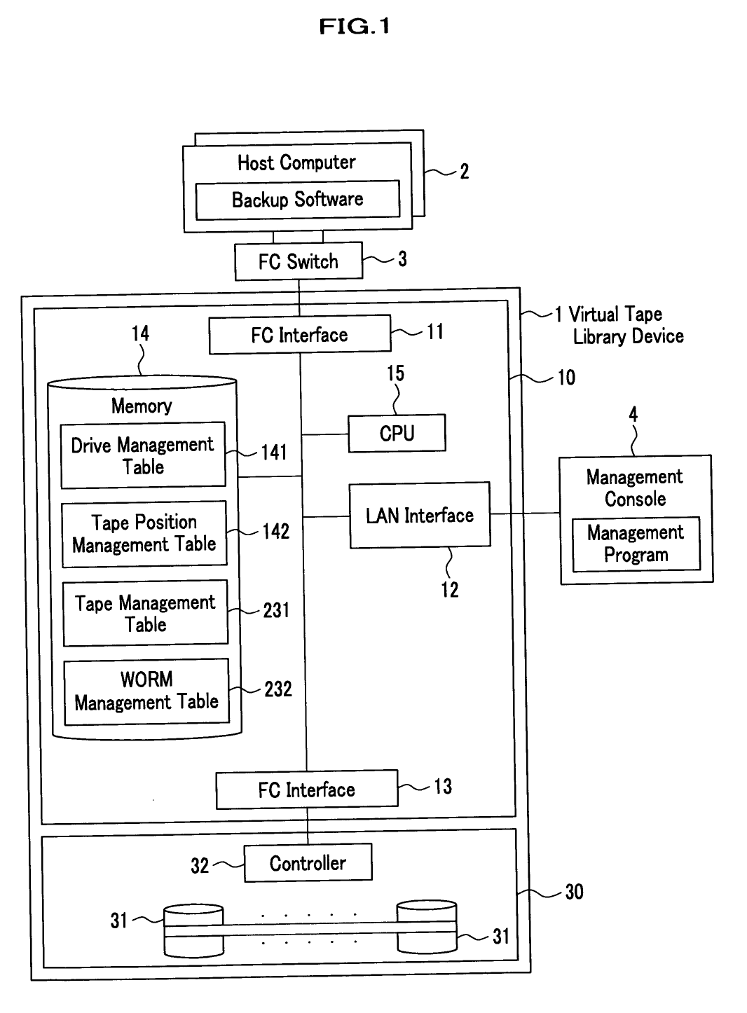

FIG. 1 is a block diagram to illustrate a general construction including a virtual tape library device according to a first embodiment of the present invention.

In FIG. 1, a virtual tape library device 1 is connected to a host computer 2 via an FC (Fibre Channel) switch 3.

The virtual tape library device 1 comprises a VTL (Virtual Tape Library) controller or control device and a disc device 30 (also referred to as a storage system). The disc device 30 comprises logical devices (memory areas) constructed from a plurality of magnetic discs 31. The logical devices provide those areas created by logically dividing a RAID (Redundant Arrays of Independent Disks) group formed from a plurality of disc devices. The disc device 30 comprises a controller 32 that controls input and output to/from the logical devices.

The VTL controller 10 performs a processing in response to a request from the host computer 2 or a management console 4, and comprises an FC interface 11, a LAN (Local Area Network) interface 12, an FC interface 13, a memory or memory device 14, and a CPU (control device) 15. The FC interfaces 11, 13 are used for the VTL controller 10 to communicate with the host computer 2 and the disc device 30, respectively. To these interfaces, various interfaces other than FC can be applied such as SCSI (Small Computer System Interface), iSCSI (Internet Small Computer System Interface), Infiniband, SATA (Serial ATA), or SAS (Serial Attached SCSI). The LAN interface 12 achieves data communication with the management console 4. Similarly, various interfaces can be applied to the LAN interface 12. It should be noted that the host computer 2 and the management console 4 are computers each including a memory and CPU. The host computer 2 operates according to a backup software, and the management console 4 to a management program.

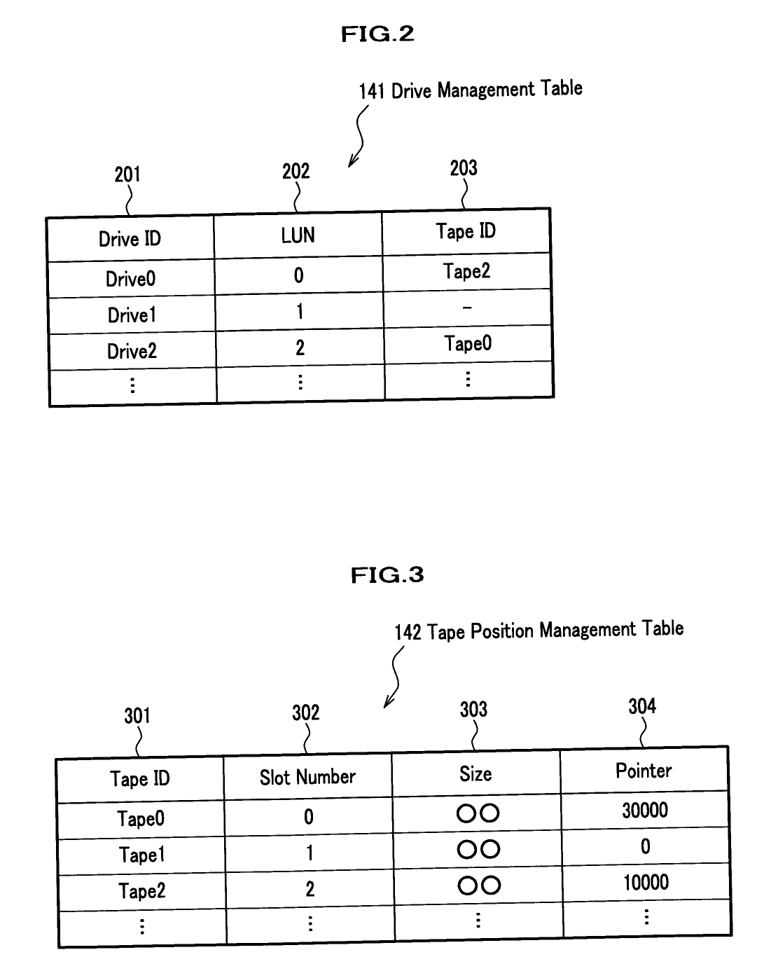

The memory 14 stores a drive management table 141, a tape position management table 142, a tape management table 231, and a WORM management table 232. In the drive management table 141, drive ID 201, LUN (Logical Unit Number) 202, and tape ID 203 are included associated to each other, as shown in FIG. 2. The drive ID identifies a virtual tape drive of the virtual tape library device, which is designated for instance as “Drive0”. The LUN 202 is the logical unit number of the virtual tape drive, which is recognized from the host computer 2 and designated for example as “0”. The tape ID is identification information of a virtual tape generated by the VTL controller 10, which is designated for instance as “Tape2”. The bar sign “-” in the Tape ID column shows that no virtual tape is mounted in the corresponding virtual tape drive.

In the tape position management table 142, tape ID 301, slot number 302, size 303, and pointer 304 are included associated to each other, as shown in FIG. 3. The tape ID 301 has a similar content with the tape ID 203 shown in FIG. 2. The slot number 302 shows a location of a slot in the virtual tape library.

The size 303 means data capacity of the virtual tape. The pointer 304 indicates the point from which to start reading and writing data in response to a request for the virtual tape.

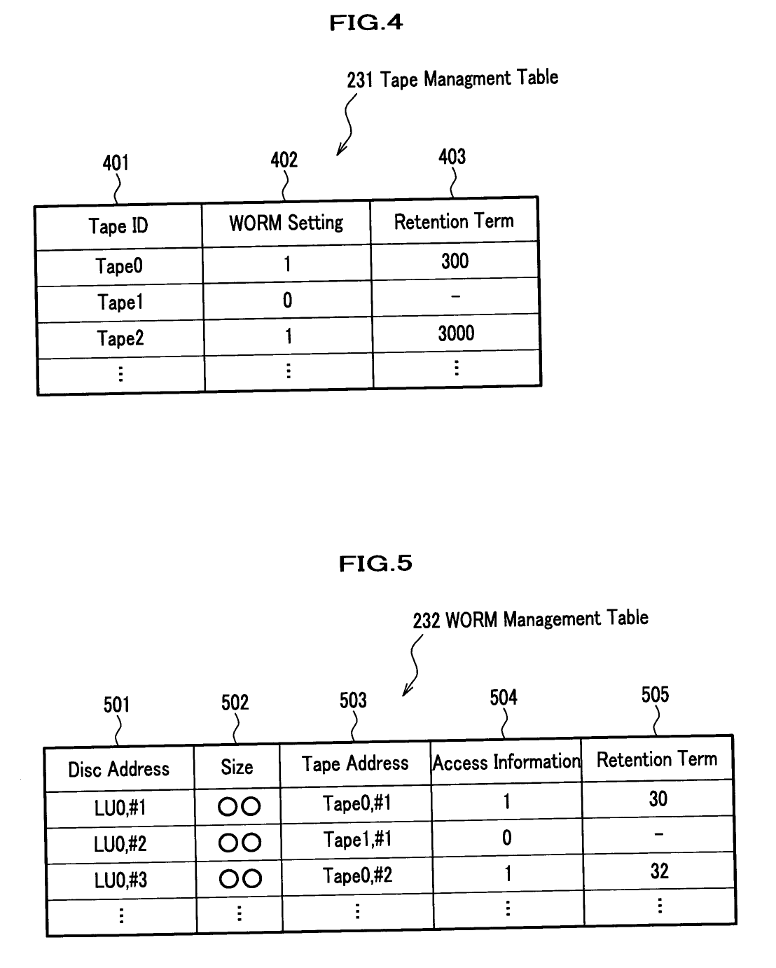

In the tape management table 231, tape ID 401, WORM setting (WORM information) 402, and retention term 403 are included associated to each other, as shown in FIG. 4.

The tape ID is identification information of the virtual tape. To make a WORM setting only for a certain area in the virtual tape, information for indicating the WORM setting target area may be added to the tape ID.

In the WORM setting 402, information is provided to indicate whether the virtual tape or the WORM setting target area in the tape should be treated as WORM, i.e. whether WORM setting should be made or not. In FIG. 4, “1” shows that WORM is set, and “0” not set.

The retention term 403 indicates a retention time period for the WORM setting, in for example the number of days for retention, remaining retention days, or retention target date. In FIG. 4, the retention term is set to “300” days. The tape ID in FIG. 4 has similar content to those presented in FIGS. 2 and 3.

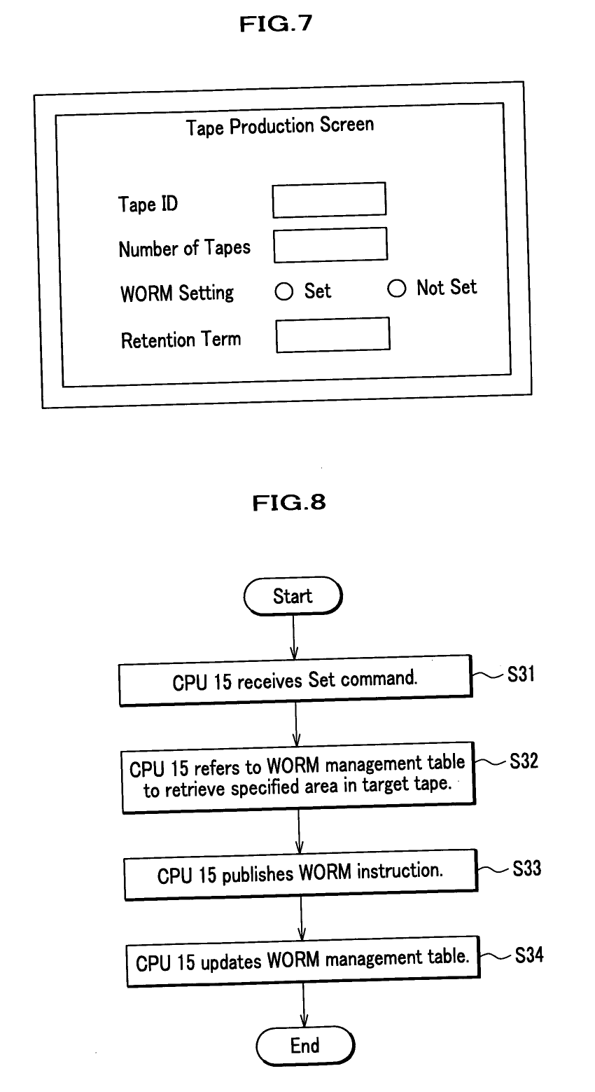

Initial setting for the tape ID 401, WORM setting 402, and retention term 403 is made by using a tape production screen as shown in FIG. 7. The screen includes “Tape ID”, “Number of Tapes”, “WORM Setting”, and “Retention Term”, and is presented on a display of the management console 4 by a management program installed therein. An administrator uses the management console 4 to make inputs to these items which are sent to the VTL controller 10. This causes the CPU 15 in the VTL controller 10 to set the tape ID 401, WORM setting 402, and retention term 43 in the tape management table 231 according to the input content on the screen. For instance, if “Yes” is selected for “WORM setting” in the tape production screen, the WORM setting 402 in the tape management table 231 is set to “1”.

“Number of Tapes” or the number of virtual tapes to be created is used to create a plurality of tapes at one time. For example, of a plurality of virtual tapes, the first virtual tape is given the number that was input to the “Tape ID”. The second tape and later are given those numbers incrementing from the number of the “Tape ID”.

In the WORM management table 232, disc address 501, size 502, tape address 503, access information 504, and retention term 505 are included associated to each other, as shown in FIG. 5. The disc address 501 shows which area in the disc device 30 to store the virtual tape data. This address is a combination of a LUN such as “LU0” used for the VTL controller 10 to accesses to the disc device 30, and an extent ID such as “#1” to indicate an area position in the LU. The extent ID is identification information of an extent, i.e. a mass of data area. Instead of the extent ID, a starting LBA (Logical Block Address) and an ending LBA may indicate a storage area. The size 502 is data capacity for each extent.

The tape address 503 identifies a memory area on the virtual tape, and is a combination of the aforementioned tape ID as shown in FIGS. 3 and 4, and the extent ID for indicating an area position in the virtual tape. As described above, the starting LBA and ending LBA may substitute for the extent ID. The access information 504 showing target area accessability, such as Read Only or Readable/Writable can be referred to in order to check if a target area is writable. The retention term 505 has similar content to the retention term 403 as shown in FIG. 4.

Thus, use of the WORM management table 232 allows grasping the correspondence between the virtual tape address 503 and the disc address 501, the latter being the address of the logical devices of the disc device 30 constructing the virtual tape.

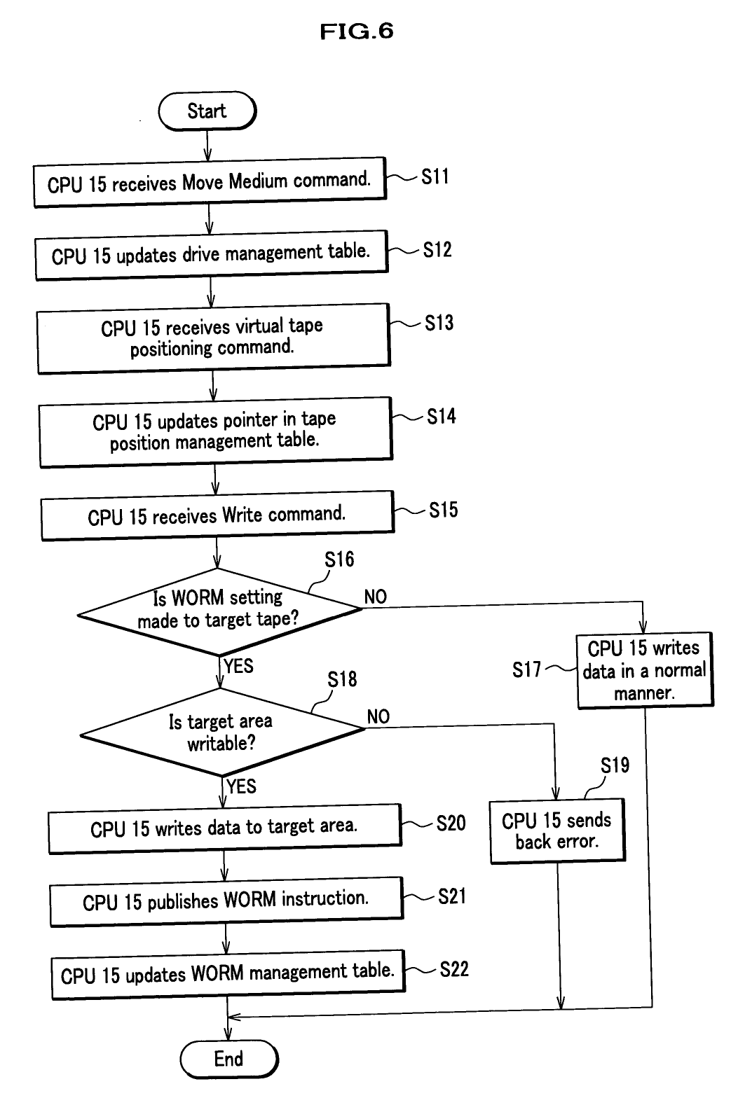

Now, referring to FIGS. 6 to 9, operation and processing of the virtual tape library device 1 will be described.

FIG. 6 is a flowchart to illustrate an exemplary operation and processing of a virtual tape library device.

First, the CPU 15 of the VTL controller 10 receives from the host computer 2 via the FC interface 11, a Move Medium command for moving a virtual tape from a slot in the virtual library device (Step 11). The CPU 15 then updates the drive management table 141 according to the command (Step 12). Suppose for example that the command is for moving the virtual tape from Slot1 to Drive1 of the virtual tape library device. Then, retrieving the slot number 302 in the tape position management table 142 will show that Tape 1 is stored in the Slot 1. Thus, the drive management table 141 is updated so that Tape 1 is associated to the tape ID 203 corresponding to Drive1 of the moving target.

Next, the CPU 15 receives a virtual tape positioning command from the host computer 2 via the FC interface 11 (Step 13). The CPU 15 updates the tape position management table shown in FIG. 3 according to the command (Step 14). For instance, if the host computer 2 issues to Drive0 a command for moving the position of the medium by a specified number of blocks, the pointer 304 corresponding to Tape2 mounted in Drive0 is rewritten to a value where the specified block number is added. The above-mentioned processes of Steps 11 to 14 are performed as needed.

The CPU 15 receives from the host computer 2 a command to write a predetermined size of data for a virtual tape drive with a LUN, e.g. “0” (Step 15). Having received the write command, the CPU 15 refers to the drive management table 141 to check the virtual tape (hereinafter also referred to as a writing target virtual tape) mounted in the drive corresponding to the LUN specified by the Write command (Step 16). The CPU 15 then refers to the tape position management table 142 to know from the pointer 304, the writing position (writing target area) on the writing target virtual tape. After the data is written, the pointer 304 is updated according to the data size.

Next, the CPU 15 refers to the tape management table 231 (FIG. 4) to judge if WORM setting is made to the writing target virtual tape, while at the same time referring to the Retention Term 403 to check if the period has been expired.

If the WORM setting 402 of the tape management table 231 is set to “0”, it is judged that the WORM setting is not made for the target tape (“NO” of Step 16). Then, the CPU 15 uses the WORM management table 232 to specify the memory area (indicated by the disc address 501) in the logical devices that corresponds to the writing target area obtained in Step 16, and then writes the data to this memory area in a normal manner (Step 17).

If the retention term 403 is expired, the CPU 15 notifies the management console 4 to that effect, so that writing can be performed in a normal manner.

If the writing target area obtained in Step 16 is not registered in the WORM management table 232, of the free areas on the logical devices of the disc device 30, an area not registered in the disc address 501 is allotted for writing the write-data from the host computer 2. Further, to the WORM management table 232, an entry is added in which to register the disc address 501 of the area registered in the logical devices, the size 502 of the write-data, and the tape address 503 of the writing target area. Since the WORM setting is not made for the writing target virtual tape, “0” meaning data readability/writability is denoted in the access information 504.

If the WORM setting 402 is “1” in the tape management table 231, the CPU 15 judges that WORM setting is made for the target virtual tape (“YES” of Step 16), and then judges whether the write target area obtained in Step 16 is writable (Step 18). If the writing target area is not registered in the tape address 503 of the WORM management table, the area is judged to be writable because it has never been written before. Also, if the writing target area is registered in the tape address 503 in the WORM management table 232, with “0” indicating writability been set to the access information 504, then the area is judged to be writable. If a writing target area is registered in the tape address 503 of the WORM management table 232, with information indicating Read Only (“1”) been set for the access information 504, the area is judged to be unwritable.

If in this manner the area is judged to be unwritable (“NO” of Step 18), the CPU 15 sends back an error to the host computer 2 (Step 19). This prevents any data from being written to the magnetic disc, allowing protecting the data thereon.

If the area is judged to be writable (“YES” of Step 18), and if the address of the writing target area is registered in the tape address 503 in the WORM management table 232, the CPU 15 writes the write-data from the host computer 2 to a memory area in the logical devices indicated by a corresponding disc address 501 (FIG. 5).

If no address of the writing target area is registered in the tape address 503 in the WORM management table 232, of the free areas on the logical devices of the disc device 30, an area not registered in the disc address 501 is allotted for writing the write-data. At the same time, an entry is added to the WORM management table 232 for registering the disc address 501 of the area allotted in the logical devices, the size 502 of the write-data, and the tape address 503 of the writing target area (Step 20).

Next, according to a control program stored in the memory 14, the CPU 15 issues a WORM instruction for the area to which the write-data was written in Step 20 (hereinafter referred to as “WORM setting target area”), to a WORM setting program stored in the controller 32 (Step 21). The WORM instruction specifies LUN (e.g. LU0) and extent ID (e.g. #1) of the disc address, size, access mode (e.g. Read Only), and retention term of the WORM setting target area in the logical devices possessed by the disc device 30. This process may be omitted in case the controller 32 does not support setting the WORM.

The CPU 15 then updates the WORM management table 232 (Step 22). Specifically, of all the entries in the WORM management table 232, with respect to an entry in which is registered an disc address 501 with the same value as the disc address of the WORM setting target area, the access mode (e.g. “1” for Read Only) and retention term specified by the WORM instruction are registered in the access information 504 and the Retention Term 505, respectively. This prevents any data from being written to the magnetic disc from next time, allowing protecting data thereon.

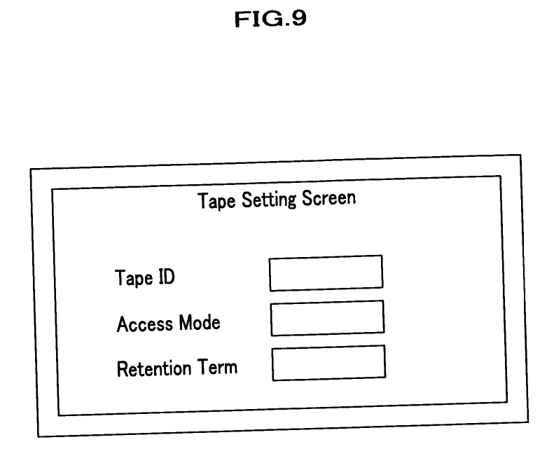

Next, referring to FIGS. 8 and 9, a process for modifying the WORM setting 402 (FIGS. 4 and 5) will be described.

In Step 31 of FIG. 8, the CPU 15 of the VTL controller 10 receives from the management console 4 a setting command that was input on the tape setting screen shown in FIG. 9. This screen includes “Tape ID”, “Access Mode” and “Retention Term”, which are contained in the command. In the “Access Mode”, access information such as WORM, Readable/Writable, and Read Only can be input. In the TapeID, only a certain area in the virtual tape may be specified, as described above. Input of “Retention Term” is arbitrary.

In Step 32, the CPU 15 refers to the WORM management table 232 (FIG. 5) to retrieve the specified area in the virtual tape specified by the setting command. The virtual tape retrieved here corresponds to the input to the “TapeID” on the tape setting screen of FIG. 9. If only a Tape ID is input into the “Tape ID”, then the entire areas of this tape are retrieved. If a Tape ID is input together with information (e.g. an extent) specifying an area in the virtual tape, then the specified area is retrieved.

In Step 33, the CPU 15 issues a WORM instruction relevant to the virtual tape area retrieved, to the controller 32 of the disc device 30. The process in Step 33 may be omitted if the controller 32 does not support setting the WORM.

Then in Step 34, according to an access mode received, the WORM management table 232 is updated so that the access mode specified for the target tape address (e.g. Read Only) is registered into the access information 504 in the WORM management table 232. This allows modifying the access mode for each virtual tape. The CPU 15 also updates the tape management table 231 in a matching manner with the updated content of the WORM management table 232.

### Second Embodiment

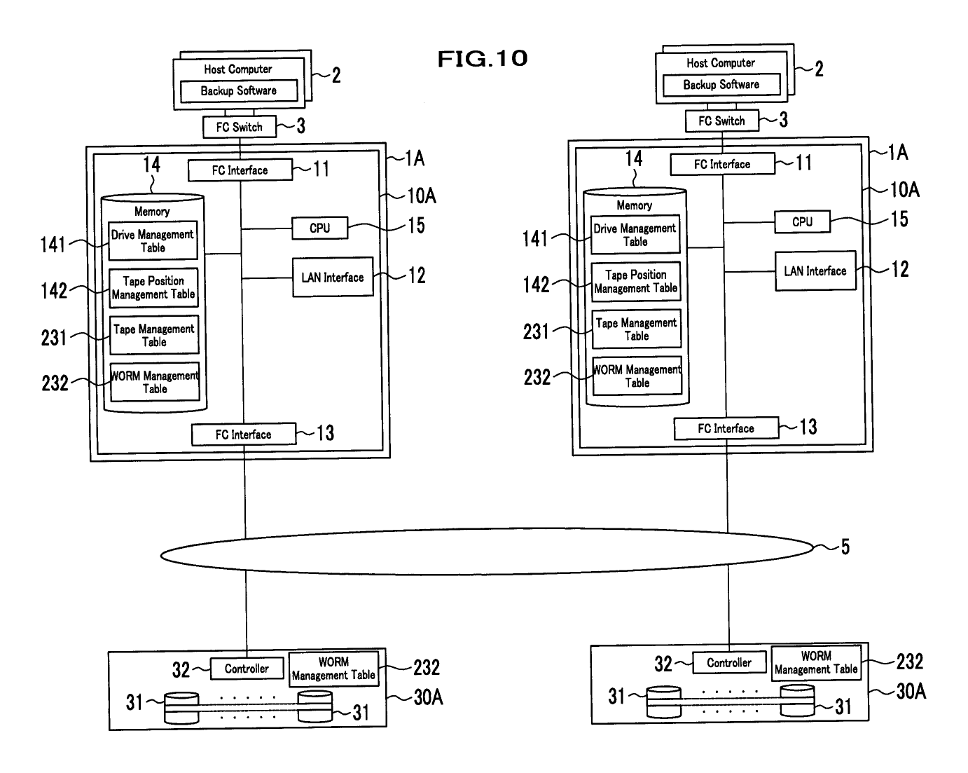

Now referring to FIG. 10, a second embodiment will be described. The same symbols are attached to the same portions as the first embodiment, which will not be described.

FIG. 10 is a block diagram to illustrate a general construction including at least one virtual tape library device according to a second embodiment of the present invention.

The second embodiment is characterized in that a plurality of VTL controllers 10A are connected to disc devices 30A via a network 5. Here it is to be noted that one or more of each of the VTL controllers 10A and the disc devices 30A may provide the construction.

The VTL controllers 10A access to a plurality of disc devices 30A via the network 5. Except for this point, each of the VTL controllers 10A is the same as the VTL controller 10 in the first embodiment. The disk devices 30A each has a WORM management table 232 stored in a magnetic disc relevant to memory areas in logical devices possessed by the disc devices 30A. When a WORM management table 232 stored in a memory 14 of each of the VTL controllers 10A is modified in content, an instruction for reflecting this modification is issued from the VTL controller 10A to the disc devices 30A. The WORM management table 232 in each of the disc devices 30A is then modified according to this instruction.

This construction is beneficial in that in response to a request from each host computer 2, a corresponding VTL controller 10A will write data to a corresponding disc device 30A via the network 5. Further, since the WORM management table 232 is also stored in each of the disc devices 30A, if for example one VTL controller 10A malfunctions, the WORM management table 232 can be read out to take over the content thereof.

The present invention is not limited to the aforementioned first and second embodiments. The construction, data structure, and processing procedure of the virtual library device may be modified within the scope of the present invention.

What is claimed is:

1. A virtual tape library device comprising a communication interface with a host computer, a disc device comprising a plurality of magnetic discs, a memory device, and a control device for controlling the communication interface, the disc device, and the memory device, wherein the memory device comprises:
a tape management table in which to make a WORM (Write Once Read Many) setting to indicate whether a virtual tape or a target area in the virtual tape should be treated as WORM; and
a WORM management table in which to store correspondence between a tape address of the virtual tape and a disc address of each of the magnetic discs; and wherein the control device performs the Steps of:
judging from the tape management table whether the WORM setting is made for the virtual tape, on receiving from the host computer via the communication interface an instruction to write write-data to the virtual tape; and
referring to the WORM management table to specify a disc address corresponding to the tape address and instructing the disc device to write the write-data to the specified disc address, if the judgment results in that the WORM setting is not made.

2. The virtual tape library device as claimed in claim 1, wherein the control device, after writing the data to the disc address, issues a WORM instruction to the disc device, specifying a disc address that indicates a target area of the writing.

3. The virtual tape library device as claimed in claim 2, wherein the control device registers an access mode relevant to access availability to the WORM management table, in association with the disc address specified by the WORM instruction.

4. The virtual tape library device as claimed in claim 1, wherein the control device instructs the writing of the data to the specified disc address, only if an access mode corresponding to the disc address indicates that writing to the disc address is possible.

5. The virtual tape library device as claimed in claim 1, wherein the WORM management table also includes a retention term for the WORM setting, and even if the judgment resulted in that the WORM setting is made, the control device refers to the WORM management table, and if the retention term for the WORM setting is expired, instructs the disc devices to write the write-data.

6. The virtual tape library device as claimed in claim 1, wherein the control device sends error information to the host computer if the judgment resulted in that the WORM setting is made, and if access information in the WORM management table indicates that writing to the disc address is disabled.

7. The virtual tape library device as claimed in claim 1, wherein the control device uses the tape management table to modify the WORM setting relevant to the specific virtual tape, in response to a request from a management console.

8. A virtual tape library system comprising a host computer, a disc device, and a computer for controlling information transfer between the host computer and the disc device, wherein:
the disc device comprises a plurality of magnetic discs; and
the computer comprises a memory device and a control device, the memory device comprising:
a tape management table in which to make a WORM (Write Once Read Many) setting to indicate whether a virtual tape or a target area in the virtual tape should be treated as WORM; and
a WORM management table in which to store correspondence between a tape address of the virtual tape and a disc address of each of the magnetic discs; and the control device of the computer performing the Steps of:
judging from the tape management table whether the WORM setting is made for the virtual tape, on receiving from the host computer via the communication interface an instruction to write write-data to the virtual tape; and
referring to the WORM management table to specify a disc address corresponding to the tape address and instructing the disc device to write the write-data to the specified disc address, if the judgment results in that the WORM setting is not made.

9. The virtual tape library system as claimed in claim 8, wherein the control device of the computer, after writing the data to the disc address, issues a WORM instruction to the disc device, specifying a disc address that indicates a target area of the writing.

10. The virtual tape library system as claimed in claim 9, wherein the control device of the computer registers an access mode relevant to access availability to the WORM management table, in association with the disc address specified by the WORM instruction.

11. The virtual tape library system as claimed in claim 8, wherein the control device of the computer instructs the writing of the data to the specified disc address, only if an access mode corresponding to the disc address indicates that writing to the disc address is enabled.

12. The virtual tape library system as claimed in claim 8, wherein the WORM management table also includes a retention term for the WORM setting, and even if the judgment resulted in that the WORM setting is made, the control device of the computer refers to the WORM management table, and if the retention term for the WORM setting is expired, instructs the disc devices to write the write-data.

13. The virtual tape library system as claimed in claim 8, wherein the control device of the computer sends error information to the host computer if the judgment resulted in that the WORM setting is made, and if access information in the WORM management table indicates that writing to the disc address is possible.

14. A method of writing data to a virtual tape of a virtual tape library used for a computer system comprising a host computer, a disc device, and a computer for controlling information transfer between the host computer and the disc device, wherein:
the disc device comprises a plurality of magnetic discs; and
the computer comprises a memory device and a control device, the memory device comprising:
a tape management table in which to make a WORM (Write Once Read Many) setting to indicate whether a virtual tape or a target area in the virtual tape should be treated as WORM; and
a WORM management table in which to store correspondence between a tape address of the virtual tape and a disc address of each of the magnetic discs; and the control device of the computer performing the Steps of:
judging from the tape management table whether the WORM setting is made for the virtual tape, on receiving from the host computer via the communication interface an instruction to write write-data to the virtual tape; and
referring to the WORM management table to specify a disc address corresponding to the tape address and instructing the disc device to write the write-data to the specified disc address, if the judgment results in that the WORM setting is not made.

15. The method of writing data to a virtual tape as claimed in claim 14, wherein the control device of the computer, after writing the data to the disc address, issues a WORM instruction to the disc device, specifying a disc address that indicates a target area of the writing.

16. The method of writing data to a virtual tape as claimed in claim 15, wherein the control device of the computer registers an access mode relevant to access availability to the WORM management table, in association with the disc address specified by the WORM instruction.

17. The method of writing data to a virtual tape as claimed in claim 14, wherein the control device of the computer instructs the writing of the data to the specified disc address, only if an access mode corresponding to the disc address indicates that writing to the disc address is enabled.

18. The method of writing data to a virtual tape as claimed in claim 14, wherein the WORM management table also includes a retention term for the WORM setting, and even if the judgment resulted in that the WORM setting is made, the control device of the computer refers to the WORM management table, and if the retention term for the WORM setting is expired, instructs the disc devices to write the write-data.

19. The method of writing data to a virtual tape as claimed in claim 14, wherein the control device of the computer sends error information to the host computer if the judgment resulted in that the WORM setting is made, and if access information in the WORM management table indicates that writing to the disc address is disabled.

20. The method of writing data to a virtual tape as claimed in claim 14, wherein the control device uses the tape management table to modify the WORM setting relevant to the specific virtual tape, in response to a request from a management console.
